(19) United States
(12) Patent Application Publication
(10) Pub. No.: US 2025/0156000 A1
(43) Pub. Date: May 15, 2025

(54) DEVICE WITH A TOUCHSCREEN WHICH COMPRISES A SELF-SUPPORTING PLATE

(71) Applicant: WAGO Verwaltungsgesellschaft mbH, Minden (DE)

(72) Inventor: Hans GIERLICH, Kirchheim unter Teck (DE)

(73) Assignee: WAGO Verwaltungsgesellschaft mbH, Minden (DE)

(21) Appl. No.: 18/944,830

(22) Filed: Nov. 12, 2024

(30) Foreign Application Priority Data
Nov. 11, 2023 (DE) 20 2023 106 618.6

(51) Int. Cl. G06F 3/041

(52) U.S. Cl. CPC G06F 3/041; G06F 2203/04103

(57) ABSTRACT

A method and a device with a touchscreen, a housing and a circuit board which is provided with a computer, wherein the touchscreen comprises a self-supporting plate and a touch-sensitive surface which is provided on the self-supporting plate, wherein the touchscreen comprises a screen which is arranged on the back of the self-supporting plate opposite the touch-sensitive surface, wherein the housing has at least one fastening element, wherein the circuit board is fastened to the housing by means of the at least one fastening element, wherein at least one flexible spacer element is attached to the circuit board surface and the screen.

This nonprovisional application claims priority under 35 U.S.C. § 119(a) to German Patent Application No. 20 2023 106 618.6, which was filed in Germany on Nov. 11, 2023, and which is herein incorporated by reference.

### BACKGROUND OF THE INVENTION

### Field of the Invention

The present invention relates to a device with a touchscreen. In particular, the present invention relates to a device with a touchscreen, which is intended for mounting in a wall recess (control panel).

### Description of the Background Art

Devices with a touchscreen that are designed to be mounted in a wall recess can be installed in a space-saving manner in confined spaces by recessing them into the wall so far that they do not, or only minimally, protrude from the wall. Furthermore, installation in a wall recess can also be advantageous in that the part of the device located in the wall is protected from unwanted environmental influences.

### SUMMARY OF THE INVENTION

It is therefore an object of the present invention to provide a device that comprises a touchscreen and a computer, wherein the touchscreen comprises a self-supporting plate on which a touch-sensitive surface of the touchscreen is provided.

In this regard, the term “touchscreen”, can be understood, in particular, as referring to a screen which is designed to detect touches on the screen surface and/or movements in the immediate vicinity of the screen surface and to convert them into signals. These signals may then be made available, for example, to a computer which may derive input actions therefrom. The input actions may relate to objects which are displayed on the screen by the computer, wherein a user may interact with the computer by interacting with said objects. The touchscreen may be part of a touch-sensitive control panel which is configured to be installed in the wall recess.

Between the screen layer, which serves to display content, and the touch-sensitive surface, there may be one or more air gaps and one or more (protective and/or otherwise functional) transparent layers and an (essentially) transparent area of the self-supporting plate. The screen (including the screen layer which serves to display content) may be arranged on the back of the self-supporting plate opposite the touch-sensitive surface.

Furthermore, the term “self-supporting plate”, can be understood, in particular, as referring to a planar component with a substantially constant thickness which has sufficient stability to allow it to withstand the mechanical stresses occurring during proper use, without additional supportive and/or protective elements. A self-supporting plate is therefore suitable, in particular, to connect (other) components of the device to each other (e.g., the self-supporting plate is suitable for connecting the housing to the screen).

The self-supporting plate may be formed from a transparent material such as glass with a thickness of 3 mm or more. For example, the self-supporting plate may be a glass plate with a thickness of 3-4 mm. Furthermore, the self-supporting plate may have at its edge a non-transparent, or at most partially transparent, layer. For example, the edge of the self-supporting plate may be painted black on the side facing the wall. The black painted area may frame the screen so that the wall behind the self-supporting plate is not visible to a viewer of the screen.

Furthermore, the self-supporting plate may be provided with a circumferential seal which is attached to the back of the self-supporting plate. If the device is mounted in the wall recess, the circumferential seal may thus be arranged between the self-supporting plate and the wall. The surrounding seal may seal the wall recess and prevent air and/or particles from the space surrounding the front of the device from entering into the wall recess or air and/or prevent particles from the wall recess from entering into the space surrounding the front of the device. The circumferential seal may be glued to the self-supporting plate.

The device may comprise a housing in which the computer is arranged, the housing being attached to the back of the self-supporting plate opposite the touch-sensitive surface.

In this regard, the term “computer”, can be understood, in particular, as referring to a functional unit comprising a processor and a memory, wherein the processor is configured to execute instructions stored in the memory. The processor and the memory may be arranged on a circuit board which is configured to be connected to the touchscreen by one or more (flexible) cables. For example, the circuit board may be (electrically) connected to the screen and a touch sensor of the touchscreen by one or more cables.

The circuit board may further be provided with communication components (e.g. an Ethernet interface) and electronic elements for power supply. Said elements may, for example, be configured to provide a supply voltage for the processor, the memory, and the touchscreen. The circuit board may further comprise a 24-volt connector and/or a Power over Ethernet (PoE) connector.

The self-supporting plate may cover the housing completely so that a wall recess is covered only by the self-supporting plate when the device is installed in the wall recess.

The housing on the back of the self-supporting plate may be set-off relative to the edges of the self-supporting plate, so that the housing is spaced apart from the edges of the self-supporting plate. The distance between the edges of the self-supporting plate and the housing may be more than 5 mm, more than 10 mm, more than 15 mm, or more than 20 mm.

The housing may comprise a mechanical mount which is configured to mount the housing in the wall recess. For example, the wall recess may be provided with one or more fastening elements into which the mount snaps when the device is inserted into the wall recess. For example, the one or more fastening elements and the mount may comprise one or more flexible elements which, when the device is inserted into the wall recess, are deflected from a rest position against a restoring force and return to the rest position (or snap back towards the rest position due to the restoring force) when the device is fully inserted, so that in this position there is a positive connection (in the insertion direction) between the one or more fastening elements and the mount. The one or more flexible elements may further be shaped in a way that when the device is removed from the recess, they will be initially deflected due to the pulling force and finally release the device.

At least one fastening element may be glued to the self-supporting plate which has locking elements and/or threads for fastening the housing. The fastening element may, for example, have an external thread, an internal thread, a receptacle for a screw nut or a threaded rod, or be a screw nut or threaded rod.

The fastening element may be made of plastic or metal. In particular, the fastening element may be formed of, or comprise, aluminum. The fastening element may be an extruded profile. The thickness of the extruded profile may be more than 3 mm, more than 4 mm, or more than 5 mm (e.g., 7 mm). The extruded profile may be glued to the self-supporting plate using a methacrylate adhesive.

Four fastening elements which are arranged parallel to four outer edges of the self-supporting plate may be glued to the self-supporting plate. The four fastening elements may be recessed in (omitted from) the corners of the self-supporting plate.

The housing may comprise at least one fastening element by means of which the circuit board is fastened to the housing, and at least one flexible spacer element which is arranged between the circuit board and the screen. The at least one flexible spacer element may be stuck to the circuit board surface. The at least one flexible spacer element may be stuck to the screen. The at least one flexible spacer element may be stuck to the circuit board surface and the screen.

When the housing is removed, the circuit board may be floatingly mounted on the screen by the flexible spacer element. When the housing is removed, the circuit board may, in particular, be floatingly mounted on the back of the screen by the flexible spacer element.

The at least one flexible spacer element may be elastic, so that the at least one flexible spacer element may be deformed, and in particular compressed or stretched, in the assembled state of the device and thus compensate for manufacturing tolerances.

The at least one flexible spacer element may be made of foam or rubber and have adhesive layers on its end surfaces. The at least one flexible spacer element may comprise foam. For example, the flexible spacer element may be a double-sided adhesive foam tape or pad or a double-sided adhesive cellular rubber tape or pad. The flexible spacer element may have a thickness of more than 3 mm, more than 4 mm, or more than 5 mm (e.g., 6 mm, 10 mm, or 15 mm).

The circuit board may comprise at least one fastening element, in particular a thread, which may be accessible from outside the housing through an opening in the housing, wherein a fastener, in particular a screw, connected to the fastening element extends, preferably, through a hollow dome or fastening dome, for example, a fastening dome with a channel for receiving the fastener, which is manufactured in one piece with the housing. If the fastening element of the circuit board is a thread, a threaded bolt may also be screwed into it, which makes it possible to have a housing without hollow domes (e.g., a sheet metal housing).

Furthermore, there may be no frame to which both, the circuit board and the housing, are (directly) attached. I.e., instead of the housing and the circuit board being (directly) attached to a frame which is connected to the touchscreen, the circuit board may be attached to the housing and the housing may be attached to the self-supporting plate of the touchscreen.

A method according to the invention comprises arranging the at least one flexible spacer element on the back of the touchscreen, placing the circuit board on the at least one flexible spacer element, fastening the housing to the self-supporting plate and fastening the circuit board to the housing.

The method may further comprise connecting the circuit board to the touchscreen using one or more flexible cables. The one or more flexible cables may not exceed a predetermined length, wherein not exceeding the predetermined length prevents the circuit board from being connected to the touchscreen when the circuit board is attached to the housing. The predetermined length may, for example, result from requirements with respect to the electromagnetic compatibility of the device.

The at least one flexible spacer element may adhere or stick to the back of the touchscreen. The circuit board may adhere or stick to the at least one flexible spacer element.

The arranging of the at least one flexible spacer element on the back of the touchscreen may comprise arranging a template on the back of the touchscreen. The template may comprise at least one opening indicating where the at least one flexible spacer element is to be placed on the back of the touchscreen.

Notably, the features described in connection with the method may also be features of the device to which the method pertains, and vice versa.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a schematic representation of a device according to an example;

FIG. 2 shows the device shown in FIG. 1 and a circuit board arranged in the device;

FIG. 3 shows the device shown in FIG. 2 and a housing enclosing the circuit board;

FIG. 4 illustrates the mounting of the device shown in FIG. 3 in a wall recess;

FIG. 5 illustrates an alternative example to the example shown in FIG. 4; and

FIG. 6 shows a flow chart of a method according to the invention.

### DETAILED DESCRIPTION

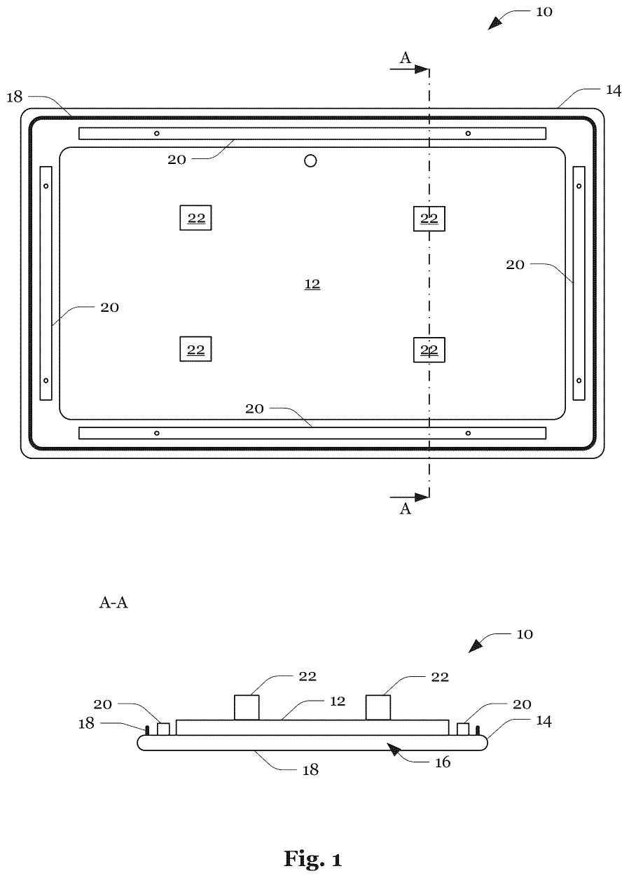

FIG. 1 shows a rear view of a touchscreen 10. The touchscreen 10 comprises a screen 12 which is arranged on a transparent self-supporting plate 14 (air gap bonding). The self-supporting plate 14 is made of glass and has a thickness of 3-4 mm. As indicated in the sectional view, there are one or more touch-sensitive sensors 16 (capacitive touch sensor) between the screen 12 and the self-supporting plate 14 (which may be comprised in foil laminated onto the screen 12 or the self-supporting plate 14). The one or more touch-sensitive sensors 16 provide for a touch-sensitive surface 18 on the self-supporting plate 14.

The self-supporting plate 14 is further provided with a seal 18 (e.g., a foam seal) which is glued all the way around the outer edge of the self-supporting plate 14, and four fastening elements 20 which are glued to the self-supporting plate 14 parallel to the four outer edges thereof and are recessed in (omitted from) the corners of the self-supporting plate 14. Additionally, four flexible spacer elements 22 are stuck to the back of the screen 12. To position the flexible spacer elements 22, a template may be used which has four openings which specify the positions of the flexible spacer elements 22.

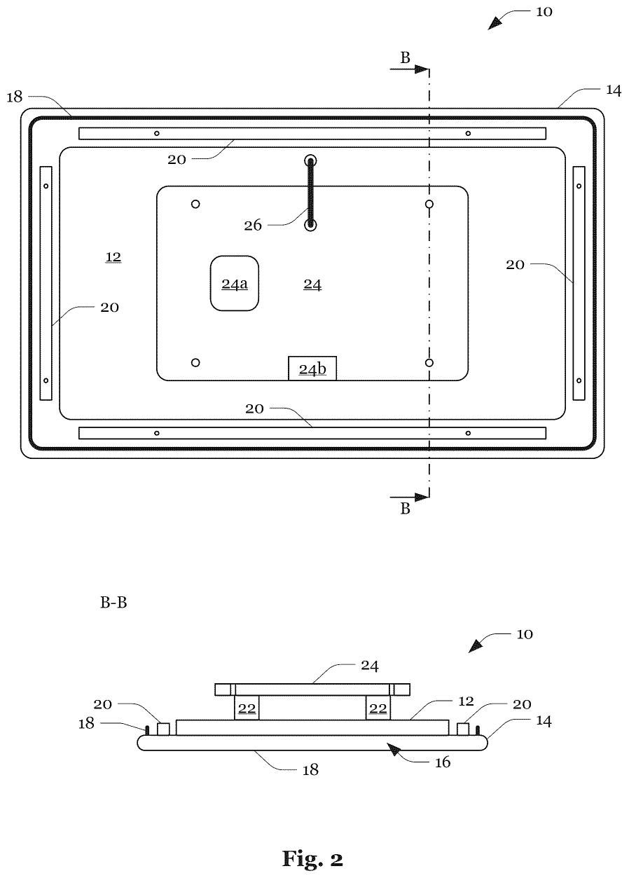

As shown in FIG. 2, during assembly of the touchscreen 10, a circuit board 24 is stuck onto the flexible spacer elements 22 and electrically connected to the touchscreen 10 via a flexible cable 26. For reasons of electromagnetic compatibility, the flexible cable 26 should be as short as possible so that it has little or almost no play (free length) when it connects the circuit board 24 to the touchscreen 10. Thus, lifting the circuit board 24 from the flexible spacer elements 22 with the flexible cable 26 plugged in would only be possible by performing a pivoting movement.

The circuit board 24 is provided with a computer 24a and an Ethernet interface 24b. The Ethernet interface may be configured to allow for a power supply to the circuit board 24 via Ethernet (Power over Ethernet, PoE). The computer 24a comprises a processor and a memory and is configured to display content on the touchscreen 10 and to process the signals from the one or more touch-sensitive sensors 16. For example, the computer 24a may be provided with an operating system comprising an Internet browser by which a user may access an HTML page via the Ethernet interface 24b.

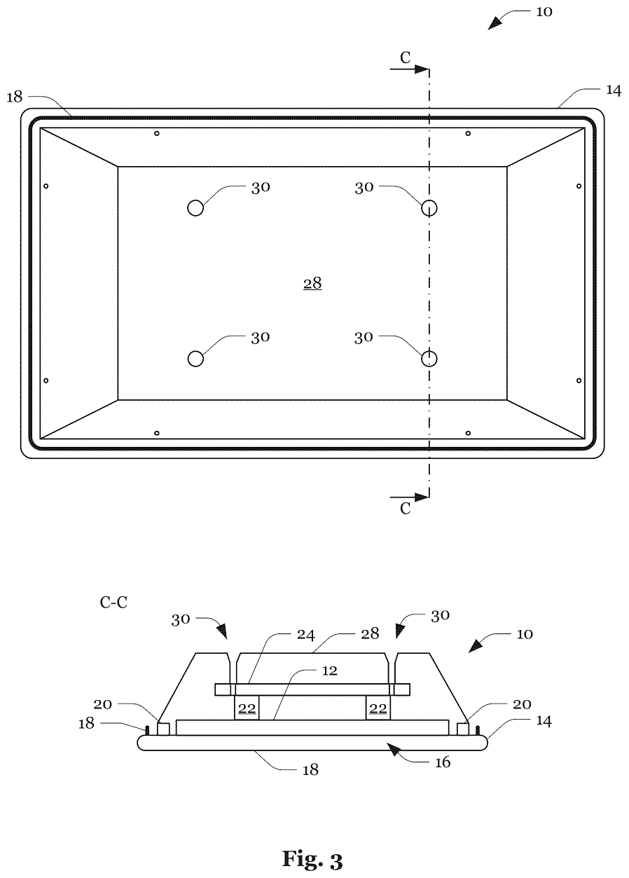

If the circuit board 24 is stuck to the flexible spacer elements 22 and electrically connected to the touchscreen 10 via a flexible cable 26, the housing 28 (e.g., a plastic injection-molded part or a sheet metal housing) is placed on the fastening elements 20 and fastened to them by means of screws, as shown in FIG. 3. When the housing 28 sits on the fastening elements 20, the fastening domes 30 are arranged over the mating threads of the circuit board 24 so that the circuit board 24 can be fastened to the housing 28 by means of screws. The flexibility of the flexible spacer elements 22 means that any offset that may occur between the fastening domes 30 and the counter threads can be compensated by moving the circuit board 24, with only slight restoring forces acting on the circuit board 24.

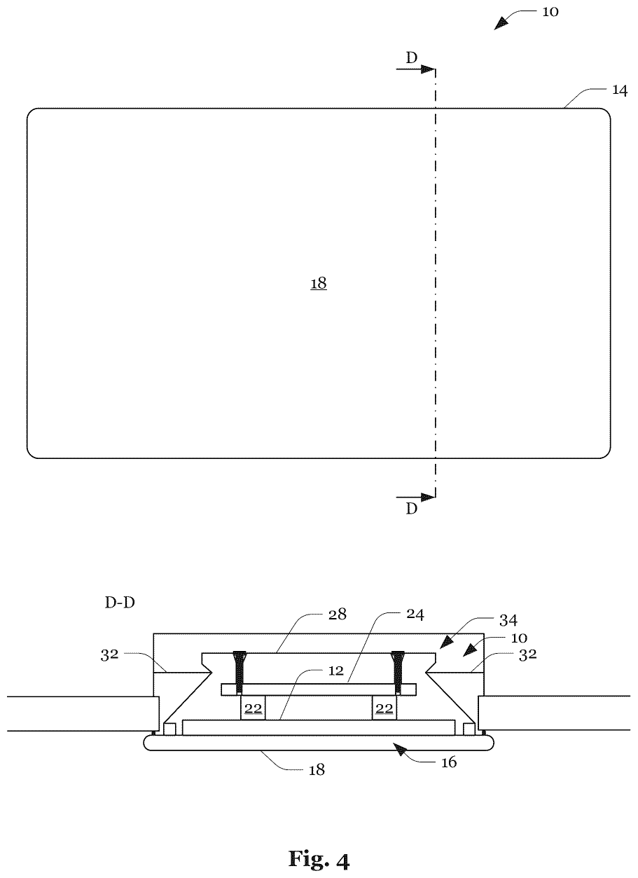

Once the housing 28 is attached to the fastening elements 20 and the circuit board 24 is attached to the housing 28, the touchscreen 10 may be inserted into a wall recess. FIG. 4 shows the front view of the touchscreen 10 mounted in the wall recess. The wall recess is provided with two fastening elements 32 into which the housing 28 snaps when the device 34 is inserted into the wall recess. When the device 34 is pushed into the wall recess, the fastening elements 32 are deflected from the rest position and snap back into the rest position when the device 34 is completely pushed in.

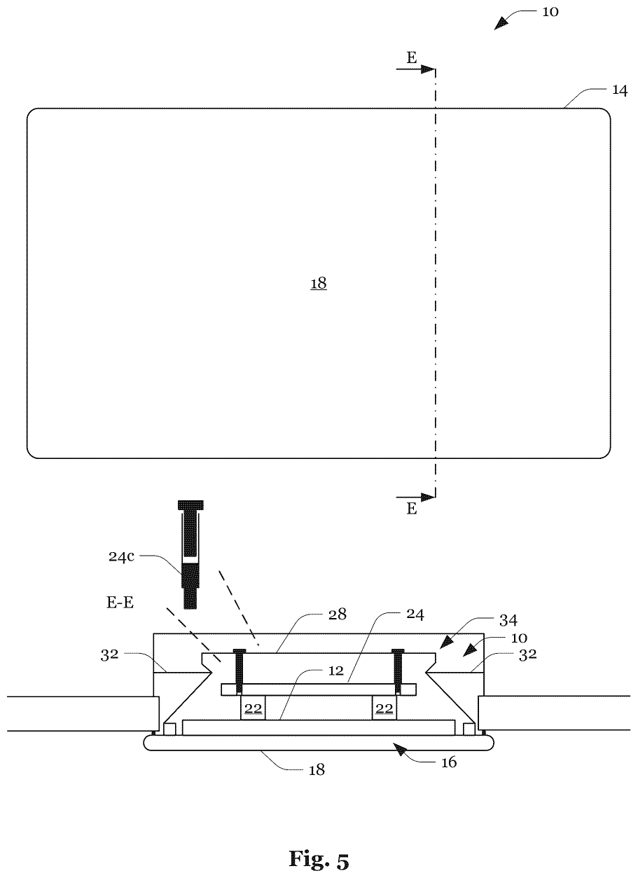

As shown in FIG. 5, threaded bolts 24c may be screwed into the threads of the circuit board 24 and screwed to the housing 28. As a result, the fastening domes 30 are no longer required.

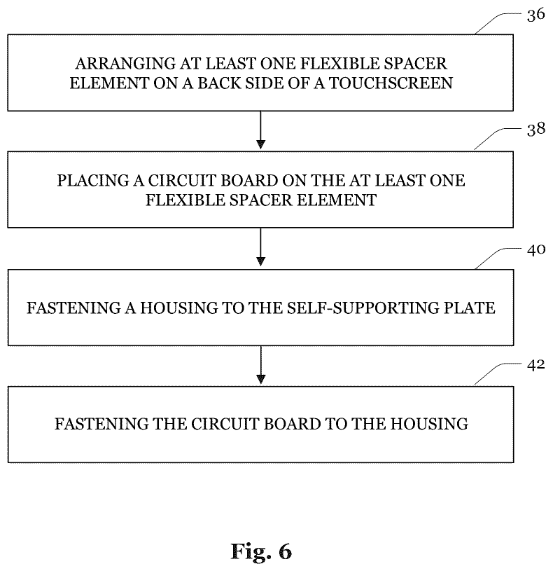

FIG. 6 shows a flow chart the assembly. This begins in step 36 with the arrangement of the flexible spacer elements 22 on the back of the touchscreen 10. In step 38, the circuit board 24 is then placed on the flexible spacer elements 22. After placing the circuit board 24 on the flexible spacer elements 22 and connecting the circuit board 24 to the touchscreen 10 by means of the flexible cable 26, the housing 28 may be fastened to the fastening elements 20 of the self-supporting plate 14 in step 40. After or at the time of fastening the housing 28 to the fastening elements 20 of the self-supporting plate 14, the circuit board 24 may be fastened to the housing 28 in step 42. The fully assembled device 34 may then be mounted in a wall recess.

The assembly process described above eliminates the need for a (metal) mounting frame that connects the circuit board 24 to the touchscreen 10. Omitting the mounting frame is advantageous in that the production of the mounting frame is complex and therefore accounts for a significant proportion of the manufacturing costs of the panel. Furthermore, assembly is accelerated because no mounting plates or adapters are required since the circuit board 24 can be attached directly to the housing 28.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A device comprising:
a touchscreen comprising a self-supporting plate, a touch-sensitive surface provided on a front of the self-supporting plate, and a screen that is arranged on the back of the self-supporting plate;
a housing that comprises at least one fastening element;
a circuit board which is provided with a computer, the circuit board being fastened to the housing via the at least one fastening element; and
at least one flexible spacer element that is affixed to a circuit board surface, the at least one flexible spacer element being affixed stuck to the screen.

2. The device of claim 1, wherein the circuit board is electrically connected to a touch sensor of the touch-sensitive surface and/or the screen by at least one flexible cable.

3. The device of claim 1, wherein, when the housing is removed, the circuit board is floatingly mounted on the screen by the flexible spacer element.

4. The device of claim 1, wherein the at least one flexible spacer element is elastic so that the at least one flexible spacer element is adapted to be deformed, compressed, or stretched in the assembled state of the device.

5. The device of claim 1, wherein the at least one flexible spacer element is made of foam or is rubber-like, or comprises foam.

6. The device of claim 1, wherein the at least one flexible spacer element has adhesive layers on its end surfaces.

7. The device of claim 1, wherein the circuit board comprises at least one fastening element, in particular a thread, which is accessible from outside the housing through an opening in the housing, wherein a fastener, in particular a screw, which is connected to the fastening element extends through a hollow dome, or fastening dome, or a fastening dome with a channel for receiving the fastener, manufactured in one piece with the housing.

8. The device of claim 1, wherein the device does not comprise a frame to which both, the circuit board and the housing, are attached.

9. The device of claim 1, wherein the touchscreen is part of a touch-sensitive control panel which is configured to be installed in the wall recess.

10. The device of claim 1, wherein the self-supporting plate formed of a transparent material or glass, and has a thickness of 3 mm or more.

11. The device of claim 1, wherein an edge of the self-supporting plate is provided with a layer which is not, or at most partially, transparent.

12. The device of claim 1, wherein the self-supporting plate has a circumferential seal which is arranged on an edge of the self-supporting plate.

13. A method comprising:
arranging at least one flexible spacer element on a back side of a touchscreen, the touchscreen comprising a self-supporting plate and a touch-sensitive surface provided on the self-supporting plate;
placing a circuit board on the at least one flexible spacer element;
fastening a housing to the self-supporting plate; and
fastening the circuit board to the housing.

14. The method of claim 13, further comprising connecting the circuit board to the touchscreen using one or more flexible cables.

15. The method of claim 14, wherein the one or more flexible cables do not exceed a predetermined length, wherein not exceeding the predetermined length prevents the circuit board from being connected to the touchscreen when the circuit board is attached to the housing.

16. The method of claim 14, wherein the at least one flexible spacer element adheres or sticks to the back of the touchscreen and the circuit board adheres or sticks to the at least one flexible spacer element.

17. The method of claim 14, wherein the arranging of the at least one flexible spacer element on the back of the touchscreen comprises arranging a template on the back of the touchscreen.
